(19) United States
(12) Patent Application Publication
(10) Pub. No.: US 2026/0071694 A1
(43) Pub. Date: Mar. 12, 2026

(54) SYSTEM AND METHOD FOR DETERMINING PRESENCE OF CONTAMINANTS IN A FUEL VALVE

(71) Applicant: Solar Turbines Incorporated, San Diego, CA (US)

(72) Inventors: David McConnell Higdon, San Diego, CA (US); Christian Marcus Cook, Waxhaw, NC (US); Samaneh Nobakht, Chula Vista, CA (US); Henry Sepulveda, San Diego, CA (US)

(73) Assignee: Solar Turbines Incorporated, San Diego, CA (US)

(21) Appl. No.: 18/802,440

(22) Filed: Aug. 13, 2024

(51) Int. Cl. F16K 37/00; F02C 7/232; G05B 15/02

(52) U.S. Cl. CPC F16K 37/0091; F02C 7/232; G05B 15/02

(57) ABSTRACT

A system for determining presence of contaminants in a fuel valve of an engine includes a pressure sensor that generates a current discharge pressure value at an outlet of a compressor and a controller including a processor. The processor receives an engine fuel requirement, determines a fuel valve command for the fuel valve, receives the current discharge pressure value, determines a maximum allowable fuel valve command and a required percentage of maximum allowable fuel valve command for the fuel valve to meet the fuel requirement, and determines the presence of contaminants based on comparison between the required percentage of maximum allowable fuel valve command and an expected percentage of maximum allowable fuel valve command for the fuel valve, one or more historical percentage of maximum allowable fuel valve commands for the fuel valve, and/or a threshold range for a percentage of maximum allowable fuel valve command for the fuel valve.

### TECHNICAL FIELD

The present disclosure relates to an engine system, and more particularly to, a system and a method for determining presence of contaminants in a fuel valve associated with an engine.

### BACKGROUND

An engine, such as a gas turbine engine, is used as a power source in various machines. The gas turbine engine includes a compressor to compress air. The gas turbine engine also includes a fuel valve that supplies fuel to a combustor, via a fuel injector. The compressed air mixes with the fuel inside the combustor to generate power.

In some cases, the fuel may include contaminants, such as, sulfur, water, etc. that may cause degradation of the fuel valve. Such contaminants may affect a performance of the fuel valve and may result in unstable and inefficient operation of the gas turbine engine. Further, build-up of contaminants in the fuel valve may cause corrosion of the fuel valve, which may require replacement of the fuel valve. Further, presence of contaminants in the fuel valve may reduce an amount of fuel flow through the fuel valve, and, in some cases may cause complete shutdown of the gas turbine engine, which may increase down time associated with the gas turbine engine.

U.S. Pat. No. 8,589,087 describe systems, methods, and apparatus for monitoring corrosion or corrosive contaminants associated with liquid fuel. According to an example embodiment of the invention, a method is provided for monitoring and predicting corrosion. The method can include monitoring corrosion or corrosive contaminants associated with liquid fuel in a fuel supply system of a gas turbine, predicting, based at least in part on the monitoring, a cumulative level of corrosion of one or more components associated with a gas turbine, and outputting information associated with the monitoring.

### SUMMARY

In an aspect of the present disclosure, a system for determining presence of contaminants in a fuel valve associated with an engine is provided. The engine includes a compressor. The system includes a pressure sensor configured to generate an input signal indicative of a current discharge pressure value at an outlet of the compressor. The system also includes a controller including a memory and a processor. The processor is communicably coupled with the memory and the pressure sensor. The memory is configured to store at least one of a plurality of expected percentage of maximum allowable fuel valve commands for the fuel valve at different discharge pressure values at the outlet of the compressor, a plurality of historical percentage of maximum allowable fuel valve commands for the fuel valve at different discharge pressure values, and a threshold range for a percentage of maximum allowable fuel valve command for the fuel valve at different discharge pressure values. The processor is configured to receive a fuel requirement of the engine to meet a desired load condition on the engine. The processor is also configured to determine a fuel valve command for the fuel valve based on the fuel requirement of the engine. The processor is further configured to receive the input signal from the pressure sensor. The processor is configured to determine a maximum allowable fuel valve command for the fuel valve based on the current discharge pressure value. The processor is also configured to determine a required percentage of maximum allowable fuel valve command for the fuel valve to meet the fuel requirement of the engine based on the determined fuel valve command and the determined maximum allowable fuel valve command. The processor is further configured to compare the required percentage of maximum allowable fuel valve command with at least one of an expected percentage of maximum allowable fuel valve command for the fuel valve at the current discharge pressure value, one or more historical percentage of maximum allowable fuel valve commands for the fuel valve at the current discharge pressure value, and a threshold range for the percentage of maximum allowable fuel valve command at the current discharge pressure value. The processor is configured to determine the presence of contaminants in the fuel valve if at least one of the required percentage of maximum allowable fuel valve command is greater than the expected percentage of maximum allowable fuel valve command at the current discharge pressure value, the required percentage of maximum allowable fuel valve command is greater than a historical percentage of maximum allowable fuel valve command at the current discharge pressure value, the required percentage of maximum allowable fuel valve command is increasing in comparison to the one or more historical percentage of maximum allowable fuel valve commands at the current discharge pressure value, and the required percentage of maximum allowable fuel valve command is outside the threshold range for the percentage of maximum allowable fuel valve command at the current discharge pressure value.

In another aspect of the present disclosure, an engine system is provided. The engine system includes a fuel valve. The engine system also includes an engine adapted to receive fuel from the fuel valve. The engine includes a compressor. The engine system further includes a system for determining presence of contaminants in the fuel valve. The system includes a pressure sensor configured to generate an input signal indicative of a current discharge pressure value at an outlet of the compressor. The system also includes a controller including memory and a processor. The processor is communicably coupled with the memory and the pressure sensor. The memory is configured to store at least one of a plurality of expected percentage of maximum allowable fuel valve commands for the fuel valve at different discharge pressure values at the outlet of the compressor, a plurality of historical percentage of maximum allowable fuel valve commands for the fuel valve at different discharge pressure values, and a threshold range for a percentage of maximum allowable fuel valve command for the fuel valve at different discharge pressure values. The processor is configured to receive a fuel requirement of the engine to meet a desired load condition on the engine. The processor is also configured to determine a fuel valve command for the fuel valve based on the fuel requirement of the engine. The processor is further configured to receive the input signal from the pressure sensor. The processor is configured to determine a maximum allowable fuel valve command for the fuel valve based on the current discharge pressure value. The processor is also configured to determine a required percentage of maximum allowable fuel valve command for the fuel valve to meet the fuel requirement of the engine based on the determined fuel valve command and the determined maximum allowable fuel valve command. The processor is further configured to compare the required percentage of maximum allowable fuel valve command with at least one of an expected percentage of maximum allowable fuel valve command for the fuel valve at the current discharge pressure value, one or more historical percentage of maximum allowable fuel valve commands for the fuel valve at the current discharge pressure value, and a threshold range for the percentage of maximum allowable fuel valve command at the current discharge pressure value. The processor is configured to determine the presence of contaminants in the fuel valve if at least one of the required percentage of maximum allowable fuel valve command is greater than the expected percentage of maximum allowable fuel valve command at the current discharge pressure value, the required percentage of maximum allowable fuel valve command is greater than a historical percentage of maximum allowable fuel valve command at the current discharge pressure value, the required percentage of maximum allowable fuel valve command is increasing in comparison to the one or more historical percentage of maximum allowable fuel valve commands at the current discharge pressure value, and the required percentage of maximum allowable fuel valve command is outside the threshold range for the percentage of maximum allowable fuel valve command at the current discharge pressure value.

In yet another aspect of the present disclosure, a method for determining presence of contaminants in a fuel valve associated with an engine is provided. The engine includes a compressor. The method includes receiving, by a processor of a controller, an input signal indicative of a current discharge pressure value at an outlet of the compressor via a pressure sensor. The controller includes a memory communicably coupled with the processor. The memory is configured to store at least one of a plurality of expected percentage of maximum allowable fuel valve commands for the fuel valve at different discharge pressure values at the outlet of the compressor, a plurality of historical percentage of maximum allowable fuel valve commands for the fuel valve at different discharge pressure values, and a threshold range for a percentage of maximum allowable fuel valve command for the fuel valve at different discharge pressure values. The method also includes receiving, by the processor, a fuel requirement of the engine to meet a desired load condition on the engine. The method further includes determining, by the processor, a fuel valve command for the fuel valve based on the fuel requirement of the engine. The method includes determining, by the processor, a maximum allowable fuel valve command for the fuel valve based on the current discharge pressure value. The method also includes determining, by the processor, a required percentage of maximum allowable fuel valve command for the fuel valve to meet the fuel requirement of the engine based on the determined fuel valve command and the determined maximum allowable fuel valve command. The method further includes comparing, by the processor, the required percentage of maximum allowable fuel valve command with at least one of an expected percentage of maximum allowable fuel valve command for the fuel valve at the current discharge pressure value, one or more historical percentage of maximum allowable fuel valve commands for the fuel valve at the current discharge pressure value, and a threshold range for the percentage of maximum allowable fuel valve command at the current discharge pressure value. The method includes determining, by the processor, the presence of contaminants in the fuel valve if at least one of the required percentage of maximum allowable fuel valve command is greater than the expected percentage of maximum allowable fuel valve command at the current discharge pressure value, the required percentage of maximum allowable fuel valve command is greater than a historical percentage of maximum allowable fuel valve command at the current discharge pressure value, the required percentage of maximum allowable fuel valve command is increasing in comparison to the one or more historical percentage of maximum allowable fuel valve commands at the current discharge pressure value, and the required percentage of maximum allowable fuel valve command is outside the threshold range for the percentage of maximum allowable fuel valve command at the current discharge pressure value.

Other features and aspects of this disclosure will be apparent from the following description and the accompanying drawings.

### BRIEF DESCRIPTION OF THE DRAWINGS

FIG. 1 is a schematic sectional view of engine associated with an engine system, according to an example of the present disclosure;

FIG. 2 is a schematic block diagram of a system for determining presence of contaminants in a fuel valve associated with the engine of FIG. 1, according to an example of the present disclosure;

FIG. 3 is a process flowchart for determining the presence of contaminants in the fuel valve of FIG. 2, according to an example of the present disclosure; and

FIG. 4 is a flowchart of a method for determining the presence of contaminants in the fuel valve associated with the engine of FIG. 1, according to an example of the present disclosure.

### DETAILED DESCRIPTION

Wherever possible, the same reference numbers will be used throughout the drawings to refer to the same or like parts.

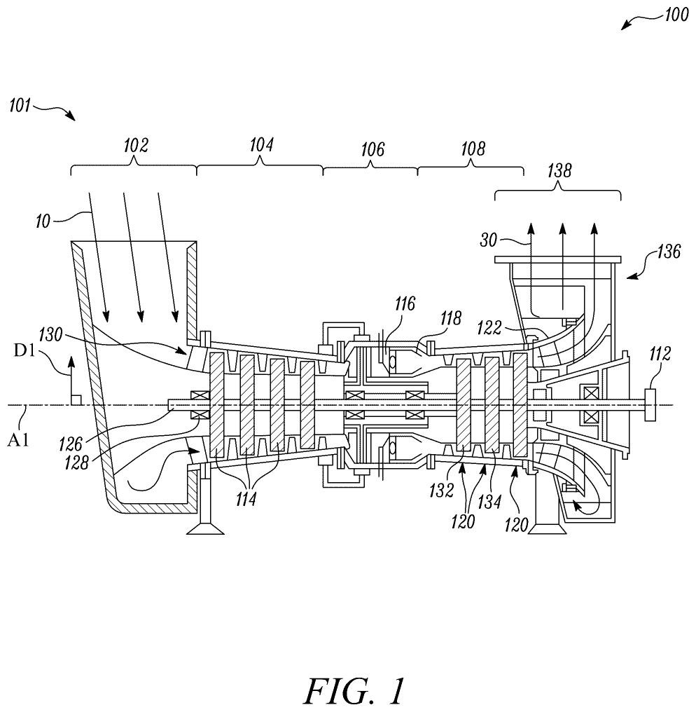

FIG. 1 is a schematic view of a portion of an exemplary engine system 100. The engine system 100 includes an engine 101. The engine 101 is embodied as a gas turbine engine herein. Alternatively, the engine 101 may embody an internal combustion engine. The engine 101 is hereinafter interchangeably referred to as “gas turbine engine 101”. Some of the surfaces of the gas turbine engine 101 have been left out or exaggerated for clarity and ease of explanation. Also, the disclosure may reference a forward and an aft direction. Generally, all references to “forward” and “aft” are associated with a flow direction of primary air (i.e., air used in combustion process), unless specified otherwise. For example, forward is “upstream” relative to primary air flow, and aft is “downstream” relative to primary air flow.

In addition, the disclosure may generally reference a center axis A1 of rotation of the gas turbine engine 101. The center axis A1 may be common to or shared with various other engine concentric components. All references to radial, axial, and circumferential directions and measures refer to the center axis A1, unless specified otherwise, and terms such as “inner” and “outer” generally indicate a lesser or greater radial distance from, wherein a radial direction D1 may be in any direction perpendicular and radiating outward from the center axis A1.

The gas turbine engine 101 includes an inlet 102, a compressor 104, a combustor 106, a turbine 108, an exhaust system 136, and a power output coupling 112. The compressor 104 includes one or more compressor rotor assemblies 114. The combustor 106 includes one or more injectors 116 and one or more combustion chambers 118. The turbine 108 includes one or more turbine rotor assemblies 120. The exhaust system 136 includes an exhaust diffuser 122. Further, the exhaust system 136 includes an engine exhaust 138. The gas turbine engine 101 also includes a shaft 126 supported by one or more bearing assemblies 128. The shaft 126 extends along the center axis A1.

As illustrated in FIG. 1, the compressor rotor assemblies 114 and the turbine rotor assemblies 120 are axial flow rotor assemblies. Each turbine rotor assembly 120 includes a rotor disk (not shown) that is circumferentially populated with corresponding turbine blades (not shown). Further, each compressor rotor assembly 114 may also include a rotor disk (not shown) that is circumferentially populated with corresponding compressor blades (not shown).

A gas (typically air 10) enters the inlet 102 as a “working fluid” and is compressed by the compressor 104. In the compressor 104, the working fluid is compressed in an annular flow path 130 by the series of compressor rotor assemblies 114. In particular, the air 10 is compressed in numbered “stages”, the stages being associated with each compressor rotor assembly 114. For example, “2^{nd} stage air” may be associated with the 2^{nd} compressor rotor assembly 114. Likewise, each turbine rotor assembly 120 may be associated with a numbered stage. For example, a first stage turbine rotor assembly 132 is the forward most of the turbine rotor assemblies 120, a second stage rotor assembly 134 is located downstream of the first stage turbine rotor assembly 132, and so on. However, other numbering/naming conventions may also be used.

The compressed air 10 leaving the compressor 104 enters the combustor 106, where the compressed air 10 is diffused and fuel is added. In some examples, the fuel may include diesel, kerosene, and the like. In other examples, the fuel may include natural gas, hydrogen, refinery gas, syn gas, and the like. The fuel is injected into the combustion chamber 118 via the one or more injectors 116 for ignition. After the combustion reaction, energy is extracted from the combusted fuel/air mixture via the turbine 108 by each stage of the series of turbine rotor assemblies 120. Exhaust gases 30 may then be diffused in the exhaust diffuser 122 after which the exhaust gases 30 may exit the gas turbine engine 101.

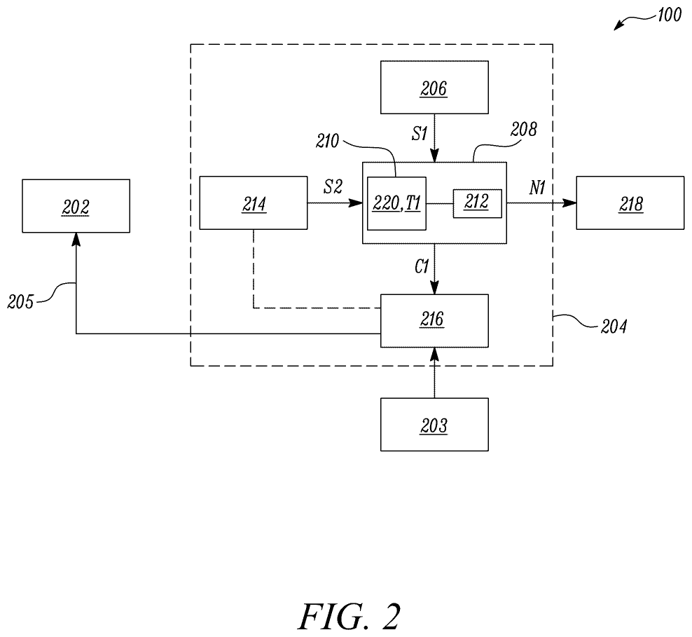

Referring to FIG. 2, a schematic block diagram of the engine system 100 is illustrated. The engine system 100 includes a fuel valve 202. The engine 101 (see FIG. 1) receives the fuel from the fuel valve 202. Specifically, the fuel valve 202 may control an amount of fuel being directed from a fuel source 203 towards the injector 116 (see FIG. 1). The fuel source 203 may be a fuel tank that can store the fuel.

The engine system 100 further includes a system 204 for determining presence of contaminants in the fuel valve 202 associated with the engine 101. In some examples, the contaminants, at least in part, includes sulfur and water. However, the contaminants may include any other particles, without any limitations. In an example, the contaminants may form restrictions in the fuel valve 202 that may decrease fuel flow towards the injector 116. Further, the contaminants may also cause corrosion of the fuel valve 202.

The system 204 includes a pressure sensor 206. The pressure sensor 206 generates an input signal S1 indicative of a current discharge pressure value at an outlet of the compressor 104 (see FIG. 1). In some examples, the pressure sensor 206 may be a piezoelectric pressure sensor, an inductive pressure sensor, an optical pressure sensor, and the like. The present disclosure is not limited by a type of the pressure sensor 206.

The system 204 also includes a controller 208. The controller 208 includes a memory 210 and a processor 212. The processor 212 is communicably coupled with the memory 210 and the pressure sensor 206. The memory 210 stores a number of expected percentage of maximum allowable fuel valve commands P1 for the fuel valve 202 at different discharge pressure values at the outlet of the compressor 104, a number of historical percentage of maximum allowable fuel valve commands P2 for the fuel valve 202 at different discharge pressure values, and/or a threshold range for a percentage of maximum allowable fuel valve command R1 for the fuel valve 202 at different discharge pressure values. The term “maximum allowable fuel valve command” as used herein corresponds to a maximum allowable opening of the fuel valve 202 for a particular discharge pressure value. Further, the term “expected percentage of maximum allowable fuel valve commands” as used herein indicates a desired/expected percentage of maximum allowable fuel valve commands to meet the fuel requirement of the gas turbine engine 101. Furthermore, the term “historical percentage of maximum allowable fuel valve commands” as used herein may be obtained and noted during previous operations of the fuel valve 202 and the gas turbine engine 101 (see FIG. 1). As such, the historical percentage of maximum allowable fuel valve command P2 may also include a preceding percentage of maximum allowable fuel valve command that may be noted during the last/previous operation of the fuel valve 202 and the gas turbine engine 101. Moreover, the term “threshold range for a percentage of maximum allowable fuel valve command” as used herein is indicative of an allowable range for the percentage of maximum allowable fuel valve command for the fuel valve 202 at a particular discharge pressure value.

The memory 210 also stores a database 220 including a number of prestored maximum allowable fuel valve commands FC1 for the fuel valve 202 at different discharge pressure values. The database 220 may include a linear model or a look-up table that includes various values for prestored maximum allowable fuel valve commands FC1 corresponding to a number of the discharge pressure values at the outlet of the compressor 104.

The memory 210 may include any means of storing information, including a hard disk, an optical disk, a floppy disk, ROM (read only memory), RAM (random access memory), PROM (programmable ROM), EEPROM (electrically erasable PROM), or other computer-readable memory media.

It should be noted that the processor 212 may embody a single microprocessor or multiple microprocessors for receiving various input signals and generating output signals. Numerous commercially available microprocessors may perform the functions of the processor 212. The processor 212 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The processor 212 may include one or more components that may be operable to execute computer executable instructions or computer code that may be stored and retrieved from the memory 210.

The system 204 further includes a heater 216 communicably coupled with the processor 212 and disposed upstream of the fuel valve 202. The heater 216 heats the fuel before the fuel enters the fuel valve 202. Further, the heater 216 is disposed between the fuel source 203 and the fuel valve 202. The heater 216 is in fluid communication with the fuel valve 202 via a fuel supply line 205.

The processor 212 receives a fuel requirement of the engine 101 to meet a desired load condition on the engine 101. The processor 212 also determines a fuel valve command FV1 for the fuel valve 202 based on the fuel requirement of the engine 101. The term “fuel valve command” as used herein may relate to a desired amount of opening of the fuel valve 202 to meet the fuel quantity requirements as per the desired load condition on the engine 101.

The processor 212 further receives the input signal S1 from the pressure sensor 206. Further, the processor 212 determines a maximum allowable fuel valve command FV2 for the fuel valve 202 based on the current discharge pressure value. In an example, the processor 212 queries the database 220 to determine the maximum allowable fuel valve command FV2 corresponding to the current discharge pressure value. Specifically, the processor 212 retrieves the maximum allowable fuel valve command FV2 from the memory 210 as per the current discharge pressure value. The processor 212 also determines a required percentage of maximum allowable fuel valve command P3 for the fuel valve 202 to meet the fuel requirement of the engine 101 based on the determined fuel valve command FV1 and the determined maximum allowable fuel valve command FV2. The term “required percentage of maximum allowable fuel valve command” as used herein is indicative of a percentage opening of the fuel valve 202 that may allow supply of the required amount of fuel to the engine 102, via the fuel valve 202, in order to meet the desired load condition on the engine 101.

Further, the processor 212 compares the required percentage of maximum allowable fuel valve command P3 with an expected percentage of maximum allowable fuel valve command P1 for the fuel valve 202 at the current discharge pressure value, one or more historical percentage of maximum allowable fuel valve commands P2 for the fuel valve 202 at the current discharge pressure value, and/or a threshold range for the percentage of maximum allowable fuel valve command R1 at the current discharge pressure value.

Furthermore, the processor 212 determines the presence of contaminants in the fuel valve 202 if the required percentage of maximum allowable fuel valve command P3 is greater than the expected percentage of maximum allowable fuel valve command P1 at the current discharge pressure value, the required percentage of maximum allowable fuel valve command P3 is greater than a historical percentage of maximum allowable fuel valve command P2 at the current discharge pressure value, the required percentage of maximum allowable fuel valve command P3 is increasing in comparison to the one or more historical percentage of maximum allowable fuel valve commands P2 at the current discharge pressure value, and/or the required percentage of maximum allowable fuel valve command P3 is outside the threshold range for the percentage of maximum allowable fuel valve command R1 at the current discharge pressure value.

The system 204 further includes a temperature sensor 214 communicably coupled to the processor 212. In an example, the temperature sensor 214 may be disposed within the fuel supply line 205. In another example, the temperature sensor 214 may be disposed in the heater 216. In yet another example, the temperature sensor 214 may be disposed downstream of the fuel valve 202. The temperature sensor 214 generates a temperature signal S2 indicative of a current temperature of fuel flowing through the fuel valve 202. The temperature sensor 214 may include a thermocouple, a resistance temperature detector, a thermistor, a semiconductor-based temperature sensor, and the like. The present disclosure is not limited by a type of the temperature sensor 214.

Further, the processor 212 compares the current temperature of the fuel flowing through the fuel valve 202 with a predefined temperature value T1 of the fuel. The predefined temperature value T1 is stored within the memory 210. The predefined temperature value T1 may correspond to a fuel temperature at which a possibility of build-up of contaminants in the fuel valve 202 may be minimal. Moreover, the processor 212 determines the presence of contaminants in the fuel valve 202 if the current temperature of the fuel is lesser than the predefined temperature value T1 of the fuel.

The engine system 100 further includes a user interface 218. The user interface 218 is communicably coupled with the processor 212. In some examples, the user interface 218 may include any input/output device. In an example, the user interface 218 may embody a display unit that may display various information associated with the engine 101. In other examples, the user interface 218 may include a portable or a handheld device, such as, a smart phone, a laptop, a tablet, and the like. Further, in one example, upon determining the presence of contaminants in the fuel valve 202, the processor 212 generates a notification N1 to indicate the presence of contaminants in the fuel valve 202. Specifically, the notification N1 is displayed on the user interface 218 to indicate the presence of contaminants in the fuel valve 202. In some examples, the notification N1 may be a visual indication, such as, a text message, a blinking light, an image indicating presence of contaminants, a color indication, etc., or an audio indication, such, as a tone pattern, a verbal message, etc.

In another example, upon determining the presence of contaminants in the fuel valve 202, the processor 212 controls the heater 216 to heat the fuel to reduce contaminants in the fuel valve 202. Further, the fuel is heated up to a temperature that is equal to or greater than the predefined temperature value T1 of the fuel. The processor 212 may transmit a control signal C1 to the heater 216 to heat the fuel to the temperature that is equal to or greater than the predefined temperature value T1 of the fuel.

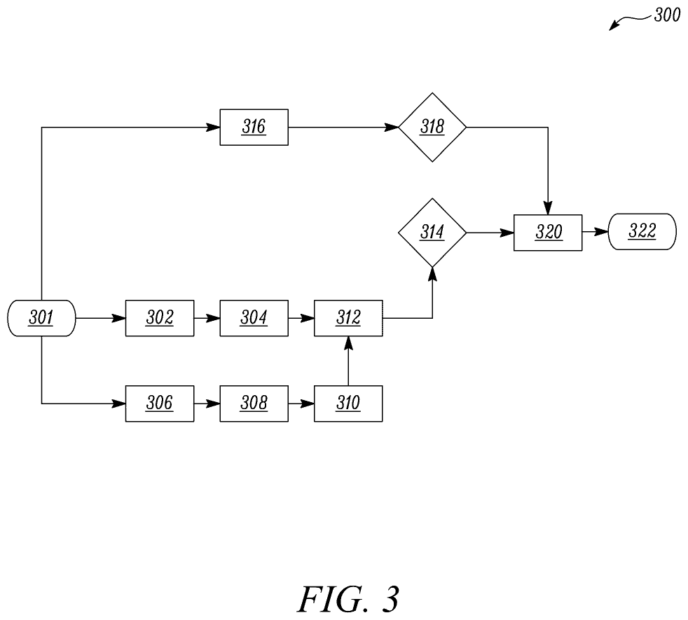

FIG. 3 illustrates a process (or an algorithm) flowchart 300 for determining the presence of contaminants in the fuel valve 202 associated with the engine 101. The process 300 explains an implementation of the system 204 illustrated in FIG. 2. Referring to FIGS. 1 to 3, the process 300 may be stored in the memory 210 of the controller 208 and retrieved for execution by the processor 212 of the controller 208.

The process 300 starts at a block 301. Further, at a block 302, the processor 212 receives the fuel requirement of the engine 101 to meet the desired load condition on the engine 101. If the load condition on the engine 101 is higher, the fuel requirement will be higher, and vice versa.

From the block 302, the process 300 moves to a block 304, at which the processor 212 determines the fuel valve command FV1 for the fuel valve 202 based on the fuel requirement of the engine 101.

Further, from the block 301, the process 300 also moves to a block 306 at which the processor 212 receives the input signal S1 indicative of the current discharge pressure value from the pressure sensor 206.

From the block 306, the process 300 moves to a block 308 at which the processor 212 queries the database 220 to determine the maximum allowable fuel valve command FV2 corresponding to the current discharge pressure value.

From the block 308, the process 300 moves to a block 310, at which the processor 212 determines the maximum allowable fuel valve command FV2 for the fuel valve 202 based on the current discharge pressure value.

From the block 310, the process 300 then moves to a block 312, at which the processor 212 determines the required percentage of maximum allowable fuel valve command P3 for the fuel valve 202 to meet the fuel requirement of the engine 101 based on the determined fuel valve command FV1 and the determined maximum allowable fuel valve command FV2. The processor 212 determines the required percentage of maximum allowable fuel valve command P3 by dividing the determined fuel valve command FV1 and the determined maximum allowable fuel valve command FV2.

From the block 312, the process 300 moves to a block 314, at which the processor 212 compares the required percentage of maximum allowable fuel valve command P3 with the expected percentage of maximum allowable fuel valve command P1 for the fuel valve 202 at the current discharge pressure value, the one or more historical percentage of maximum allowable fuel valve commands P2 for the fuel valve 202 at the current discharge pressure value, and the threshold range for the percentage of maximum allowable fuel valve command R1 at the current discharge pressure value.

Further, at the block 314, in one example, the processor 212 determines the presence of contaminants in the fuel valve 202 if the required percentage of maximum allowable fuel valve command P3 is greater than the expected percentage of maximum allowable fuel valve command P1 at the current discharge pressure value.

In another example, at the block 314, the processor 212 determines the presence of contaminants in the fuel valve 202 if the required percentage of maximum allowable fuel valve command P3 is greater than the historical percentage of maximum allowable fuel valve command P2 at the current discharge pressure value. More particularly, if the processor 212 determines that the required percentage of maximum allowable fuel valve command P3 is greater than a pre-defined limit for the historical percentage of maximum allowable fuel valve command P2, then the processor 212 may conclude the presence of contaminants in the fuel valve 202. In an example, the pre-defined limit for the historical percentage of maximum allowable fuel valve command P2 may be equal to 90%, and if the required percentage of maximum allowable fuel valve command P3 is greater than 90%, then the processor 212 may conclude the presence of contaminants in the fuel valve 202.

In yet another example, at the block 314, the processor 212 determines the presence of contaminants in the fuel valve 202 if the required percentage of maximum allowable fuel valve command P3 is increasing in comparison to the one or more historical percentage of maximum allowable fuel valve commands P2 at the current discharge pressure value. More particularly, if the processor 212 determines an upward trend in the required percentage of maximum allowable fuel valve command P3, the processor 212 determines the presence of contaminants in the fuel valve 202. For example, if the required percentage of maximum allowable fuel valve command P3 that may be noted on an exemplary day 1 is 75%, if the required percentage of maximum allowable fuel valve command P3 that may be noted on day 2 is 80%, and if the required percentage of maximum allowable fuel valve command P3 that may be noted during the last/previous operation is 85%, then the processor 212 may conclude the presence of contaminants in the fuel valve 202 based on the upward trend in the required percentage of maximum allowable fuel valve command P3.

In yet another example, at the block 314, the processor 212 determines the presence of contaminants in the fuel valve 202 if the required percentage of maximum allowable fuel valve command P3 for the fuel valve 202 is outside the threshold range for the percentage of maximum allowable fuel valve command R1 at the current discharge pressure value.

Further, from the block 301, the process 300 also moves to a block 316 at which the processor 212 receives the temperature signal S2 indicative of the current temperature of fuel flowing through the fuel valve 202 from the temperature sensor 214. From the block 316, the process 300 then moves to the block 318 at which the processor 212 compares the current temperature of the fuel flowing through the fuel valve 202 with the predefined temperature value T1 of the fuel. The processor 212 retrieves the predefined temperature value T1 of the fuel from the memory 210. If the current temperature of the fuel is lesser than the predefined temperature value T1 of the fuel, the processor 212 determines that contaminants may be present in the fuel valve 202.

In one example, upon determining the presence of contaminants in the fuel valve 202 at the blocks 314, 318, the process 300 moves to a block 320 at which the processor 212 controls the heater 216 to heat the fuel to the temperature that is equal to or greater than the predefined temperature value T1 of the fuel to reduce contaminants in the fuel valve 202. From the block 320, the process 300 moves to a block 322 at which the process 300 ends operation.

In another example, at the block 320, the processor 212 generates and transmit the notification N1 to the user interface 218 to indicate the presence of contaminants in the fuel valve 202.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure describes the system 204 for determining the presence of contaminants, such as, sulfur, water, etc. in the fuel valve 202 associated with the engine 101. Specifically, the system 204 may predict contamination build-up in the fuel valve 202 of the engine 101 that may otherwise corrode the fuel valve 202, degrade the fuel valve 202, and/or lead to inefficient or unstable operation of the engine 101.

The system 204 includes the controller 208. The controller 208 includes the processor 212. In one example, the processor 212 determines the presence of contaminants in the fuel valve 202 if the required percentage of maximum allowable fuel valve command P3 for the fuel valve 202 is greater than the expected percentage of maximum allowable fuel valve command P1 for the fuel valve 202 at the current discharge pressure value.

In another example, the processor 212 determines the presence of contaminants in the fuel valve 202 if the required percentage of maximum allowable fuel valve command P3 for the fuel valve 202 is greater than the historical percentage of maximum allowable fuel valve command P2 for the fuel valve 202 at the current discharge pressure value.

In yet another example, the processor 212 determines the presence of contaminants in the fuel valve 202 if the required percentage of maximum allowable fuel valve command P3 is increasing in comparison to the one or more historical percentage of maximum allowable fuel valve commands P2 at the current discharge pressure value.

In yet another example, the processor 212 determines the presence of contaminants in the fuel valve 202 if the required percentage of maximum allowable fuel valve command P3 for the fuel valve 202 is outside the threshold range for the percentage of maximum allowable fuel valve command R1 at the current discharge pressure value.

In an example, the system 204 alerts users about the presence of contaminants in the fuel valve 202 via the notification N1. Accordingly, the user may take corrective measures to reduce the contamination build-up in the fuel valve 202. In other example, the system 204 itself takes corrective actions by heating the fuel to the predefined temperature value T1 that may in turn reduce contamination build-up in the fuel valve 202. The system 204 described herein may prevent unexpected shutdown of the engine 101. Specifically, the system 204 transmits the notification N1 to the user interface 218 and the control signal C1 to the heater 216 to address the issue of contamination build-up which may prevent unexpected shutdown of the engine 101.

The system 204 may also reduce servicing and maintenance costs associated with the engine 101 by determining the presence of contaminants in the fuel valve 202, while improving performance of the engine 101. Moreover, the system 204 described herein may be cost-effective, may be retrofitted in existing engines, and may improve run time of the engine 101.

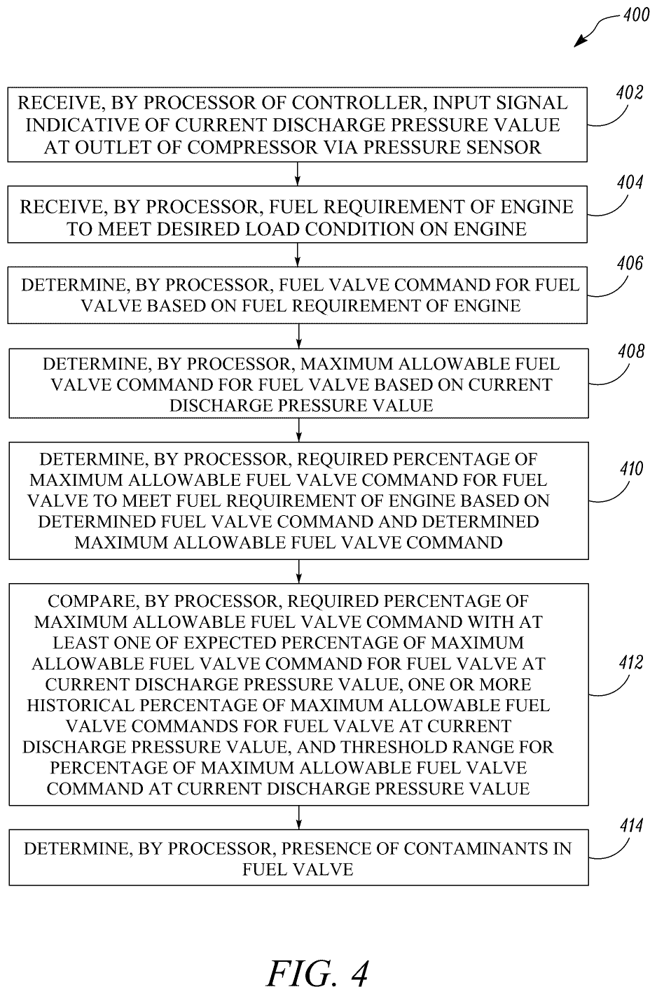

FIG. 4 is a flowchart of a method 400 for determining presence of contaminants in the fuel valve 202 associated with the engine 101. With reference to FIGS. 1 to 4, at step 402, the processor 212 of the controller 208 receives the input signal S1 indicative of the current discharge pressure value at the outlet of the compressor 104 via the pressure sensor 206. The controller 208 includes the memory 210 communicably coupled with the processor 212. The memory 210 stores the number of expected percentage of maximum allowable fuel valve commands P1 for the fuel valve 202 at different discharge pressure values at the outlet of the compressor 104, the number of historical percentage of maximum allowable fuel valve commands P2 for the fuel valve 202 at different discharge pressure values, and/or the threshold range for the percentage of maximum allowable fuel valve command R1 for the fuel valve 202 at different discharge pressure values. The memory 210 further stores the database 220 including the number of prestored maximum allowable fuel valve commands FC1 for the fuel valve 202 at different discharge pressure values.

At step 404, the processor 212 receives the fuel requirement of the engine 101 to meet the desired load condition on the engine 101.

At step 406, the processor 212 determines the fuel valve command FV1 for the fuel valve 202 based on the fuel requirement of the engine 101.

At step 408, the processor 212 determines the maximum allowable fuel valve command FV2 for the fuel valve 202 based on the current discharge pressure value. Further, the step 408 of determining the maximum allowable fuel valve command FV2 for the fuel valve 202 further includes querying, by the processor 212, the database 220 to determine the maximum allowable fuel valve command FV2 corresponding to the current discharge pressure value.

At step 410, the processor 212 determines the required percentage of maximum allowable fuel valve command P3 for the fuel valve 202 to meet the fuel requirement of the engine 101 based on the determined fuel valve command FV1 and the determined maximum allowable fuel valve command FV2.

At step 412, the processor 212 compares the required percentage of maximum allowable fuel valve command P3 with the expected percentage of maximum allowable fuel valve command P1 for the fuel valve 202 at the current discharge pressure value, one or more historical percentage of maximum allowable fuel valve commands P2 for the fuel valve 202 at the current discharge pressure value, and/or the threshold range for the percentage of maximum allowable fuel valve command R1 at the current discharge pressure value.

At step 414, the processor 212 determines the presence of contaminants in the fuel valve 202 if the required percentage of maximum allowable fuel valve command P3 is greater than the expected percentage of maximum allowable fuel valve command P1 at the current discharge pressure value, the required percentage of maximum allowable fuel valve command P3 is greater than the historical percentage of maximum allowable fuel valve command P2 at the current discharge pressure value, the required percentage of maximum allowable fuel valve command P3 is increasing in comparison to the one or more historical percentage of maximum allowable fuel valve commands P2 at the current discharge pressure value, and/or the required percentage of maximum allowable fuel valve command P3 is outside the threshold range for the percentage of maximum allowable fuel valve command R1 at the current discharge pressure value.

The method 400 further includes a step at which the temperature sensor 214 generates the temperature signal S2 indicative of the current temperature of fuel flowing through the fuel valve 202. The method 400 includes a step at which the processor 212 receives the temperature signal S2 from the temperature sensor 214. The method 400 also includes a step at which the processor 212 compares the current temperature of the fuel flowing through the fuel valve 202 with the predefined temperature value T1 of the fuel. The predefined temperature value T1 is stored within the memory 210. The method 400 further includes a step at which the processor 212 determines the presence of contaminants in the fuel valve 202 if the current temperature of the fuel is lesser than the predefined temperature value T1 of the fuel.

The method 400 further includes a step at which the heater 216 is communicably coupled with the processor 212. The heater 216 is disposed upstream of the fuel valve 202 and heat the fuel before the fuel enters the fuel valve 202. The method 400 also includes a step at which the processor 212 controls the heater 216 to heat the fuel to reduce contaminants in the fuel valve 202 upon determining the presence of contaminants in the fuel valve 202. The fuel is heated up to the temperature that is equal to or greater than the predefined temperature value T1 of the fuel.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A system for determining presence of contaminants in a fuel valve associated with an engine, the engine including a compressor, the system comprising:
a pressure sensor configured to generate an input signal indicative of a current discharge pressure value at an outlet of the compressor;
a controller including a memory, and a processor communicably coupled with the memory and the pressure sensor, wherein the memory is configured to store at least one of a plurality of expected percentage of maximum allowable fuel valve commands for the fuel valve at different discharge pressure values at the outlet of the compressor, a plurality of historical percentage of maximum allowable fuel valve commands for the fuel valve at different discharge pressure values, and a threshold range for a percentage of maximum allowable fuel valve command for the fuel valve at different discharge pressure values, and wherein the processor is configured to:
receive a fuel requirement of the engine to meet a desired load condition on the engine;
determine a fuel valve command for the fuel valve based on the fuel requirement of the engine;
receive the input signal from the pressure sensor;
determine a maximum allowable fuel valve command for the fuel valve based on the current discharge pressure value;
determine a required percentage of maximum allowable fuel valve command for the fuel valve to meet the fuel requirement of the engine based on the determined fuel valve command and the determined maximum allowable fuel valve command;
compare the required percentage of maximum allowable fuel valve command with at least one of an expected percentage of maximum allowable fuel valve command for the fuel valve at the current discharge pressure value, one or more historical percentage of maximum allowable fuel valve commands for the fuel valve at the current discharge pressure value, and a threshold range for the percentage of maximum allowable fuel valve command for the fuel valve at the current discharge pressure value; and
determine the presence of contaminants in the fuel valve if at least one of:
the required percentage of maximum allowable fuel valve command is greater than the expected percentage of maximum allowable fuel valve command at the current discharge pressure value;
the required percentage of maximum allowable fuel valve command is greater than a historical percentage of maximum allowable fuel valve command at the current discharge pressure value;
the required percentage of maximum allowable fuel valve command is increasing in comparison to the one or more historical percentage of maximum allowable fuel valve commands at the current discharge pressure value; and
the required percentage of maximum allowable fuel valve command is outside the threshold range for the percentage of maximum allowable fuel valve command at the current discharge pressure value.

2. The system of claim 1, wherein, upon determining the presence of contaminants in the fuel valve, the processor is further configured to generate a notification to indicate the presence of contaminants in the fuel valve.

3. The system of claim 1, further comprising a temperature sensor communicably coupled to the processor, wherein the temperature sensor is configured to generate a temperature signal indicative of a current temperature of fuel flowing through the fuel valve, and wherein the processor is further configured to:
compare the current temperature of the fuel flowing through the fuel valve with a predefined temperature value of the fuel, wherein the predefined temperature value is stored within the memory; and
determine the presence of contaminants in the fuel valve if the current temperature of the fuel is lesser than the predefined temperature value of the fuel.

4. The system of claim 3 further comprising a heater communicably coupled with the processor and disposed upstream of the fuel valve, wherein the heater is adapted to heat the fuel before the fuel enters the fuel valve, wherein, upon determining the presence of contaminants in the fuel valve, the processor is further configured to control the heater to heat the fuel to reduce contaminants in the fuel valve, and wherein the fuel is heated up to a temperature that is equal to or greater than the predefined temperature value of the fuel.

5. The system of claim 1, wherein the memory is further configured to store a database including a plurality of prestored maximum allowable fuel valve commands for the fuel valve at different discharge pressure values, and wherein the processor is further configured to query the database to determine the maximum allowable fuel valve command corresponding to the current discharge pressure value.

6. The system of claim 1, wherein the engine is a gas turbine engine.

7. The system of claim 1, wherein the contaminants, at least in part, includes sulfur and water.

8. An engine system comprising:
a fuel valve;
an engine adapted to receive fuel from the fuel valve, the engine including a compressor; and
a system for determining presence of contaminants in the fuel valve, wherein the system includes:
a pressure sensor configured to generate an input signal indicative of a current discharge pressure value at an outlet of the compressor;
a controller including a memory and a processor, wherein the processor is communicably coupled with the memory and the pressure sensor, wherein the memory is configured to store at least one of a plurality of expected percentage of maximum allowable fuel valve commands for the fuel valve at different discharge pressure values at the outlet of the compressor, a plurality of historical percentage of maximum allowable fuel valve commands for the fuel valve at different discharge pressure values, and a threshold range for a percentage of maximum allowable fuel valve command for the fuel valve at different discharge pressure values, and wherein the processor is configured to:
receive a fuel requirement of the engine to meet a desired load condition on the engine;
determine a fuel valve command for the fuel valve based on the fuel requirement of the engine;
receive the input signal from the pressure sensor;
determine a maximum allowable fuel valve command for the fuel valve based on the current discharge pressure value;
determine a required percentage of maximum allowable fuel valve command for the fuel valve to meet the fuel requirement of the engine based on the determined fuel valve command and the determined maximum allowable fuel valve command;
compare the required percentage of maximum allowable fuel valve command with at least one of an expected percentage of maximum allowable fuel valve command for the fuel valve at the current discharge pressure value, one or more historical percentage of maximum allowable fuel valve commands for the fuel valve at the current discharge pressure value, and a threshold range for the percentage of maximum allowable fuel valve command at the current discharge pressure value; and
determine the presence of contaminants in the fuel valve if at least one of:
the required percentage of maximum allowable fuel valve command is greater than the expected percentage of maximum allowable fuel valve command at the current discharge pressure value;
the required percentage of maximum allowable fuel valve command is greater than a historical percentage of maximum allowable fuel valve command at the current discharge pressure value;
the required percentage of maximum allowable fuel valve command is increasing in comparison to the one or more historical percentage of maximum allowable fuel valve commands at the current discharge pressure value; and
the required percentage of maximum allowable fuel valve command is outside the threshold range for the percentage of maximum allowable fuel valve command at the current discharge pressure value.

9. The engine system of claim 8, wherein, upon determining the presence of contaminants in the fuel valve, the processor is further configured to generate a notification to indicate the presence of contaminants in the fuel valve.

10. The engine system of claim 8, further comprising a temperature sensor communicably coupled to the processor, wherein the temperature sensor is configured to generate a temperature signal indicative of a current temperature of fuel flowing through the fuel valve, and wherein the processor is further configured to:
compare the current temperature of the fuel flowing through the fuel valve with a predefined temperature value of the fuel, wherein the predefined temperature value is stored within the memory; and
determine the presence of contaminants in the fuel valve if the current temperature of the fuel is lesser than the predefined temperature value of the fuel.

11. The engine system of claim 10, further comprising a heater communicably coupled with the processor and disposed upstream of the fuel valve, wherein the heater is adapted to heat the fuel before the fuel enters the fuel valve, wherein, upon determining the presence of contaminants in the fuel valve, the processor is further configured to control the heater to heat the fuel to reduce contaminants in the fuel valve, and wherein the fuel is heated up to a temperature that is equal to or greater than the predefined temperature value of the fuel.

12. The engine system of claim 8, wherein the memory is further configured to store a database including a plurality of prestored maximum allowable fuel valve commands for the fuel valve at different discharge pressure values, and wherein the processor is further configured to query the database to determine the maximum allowable fuel valve command corresponding to the current discharge pressure value.

13. The engine system of claim 8, wherein the contaminants, at least in part, includes sulfur and water.

14. The engine system of claim 8, wherein the engine is a gas turbine engine.

15. A method for determining presence of contaminants in a fuel valve associated with an engine, the engine including a compressor, the method comprising:
receiving, by a processor of a controller, an input signal indicative of a current discharge pressure value at an outlet of the compressor via a pressure sensor, wherein the controller includes memory communicably coupled with the processor, and wherein the memory is configured to store at least one of a plurality of expected percentage of maximum allowable fuel valve commands for the fuel valve at different discharge pressure values at the outlet of the compressor, a plurality of historical percentage of maximum allowable fuel valve commands for the fuel valve at different discharge pressure values, and a threshold range for a percentage of maximum allowable fuel valve command for the fuel valve at different discharge pressure values;
receiving, by the processor, a fuel requirement of the engine to meet a desired load condition on the engine;
determining, by the processor, a fuel valve command for the fuel valve based on the fuel requirement of the engine;
determining, by the processor, a maximum allowable fuel valve command for the fuel valve based on the current discharge pressure value;
determining, by the processor, a required percentage of maximum allowable fuel valve command for the fuel valve to meet the fuel requirement of the engine based on the determined fuel valve command and the determined maximum allowable fuel valve command;
comparing, by the processor, the required percentage of maximum allowable fuel valve command with at least one of an expected percentage of maximum allowable fuel valve command for the fuel valve at the current discharge pressure value, one or more historical percentage of maximum allowable fuel valve commands for the fuel valve at the current discharge pressure value, and a threshold range for the percentage of maximum allowable fuel valve command at the current discharge pressure value; and
determining, by the processor, the presence of contaminants in the fuel valve if at least one of:
the required percentage of maximum allowable fuel valve command is greater than the expected percentage of maximum allowable fuel valve command at the current discharge pressure value;
the required percentage of maximum allowable fuel valve command is greater than a historical percentage of maximum allowable fuel valve command at the current discharge pressure value;
the required percentage of maximum allowable fuel valve command is increasing in comparison to the one or more historical percentage of maximum allowable fuel valve commands at the current discharge pressure value; and
the required percentage of maximum allowable fuel valve command is outside the threshold range for the percentage of maximum allowable fuel valve command at the current discharge pressure value.

16. The method of claim 15 further comprising generating, by the processor, a notification to indicate the presence of contaminants in the fuel valve upon determining the presence of contaminants in the fuel valve.

17. The method of claim 15 further comprising:
generating, via a temperature sensor, a temperature signal indicative of a current temperature of fuel flowing through the fuel valve;
receiving, by the processor, the temperature signal from the temperature sensor;
comparing, by the processor, the current temperature of the fuel flowing through the fuel valve with a predefined temperature value of the fuel, wherein the predefined temperature value is stored within the memory; and
determining, by the processor, the presence of contaminants in the fuel valve if the current temperature of the fuel is lesser than the predefined temperature value of the fuel.

18. The method of claim 17 further comprising:
communicably coupling a heater with the processor, wherein the heater is disposed upstream of the fuel valve and is adapted to heat the fuel before the fuel enters the fuel valve; and
controlling, by the processor, the heater to heat the fuel to reduce contaminants in the fuel valve upon determining the presence of contaminants in the fuel valve, wherein the fuel is heated up to a temperature that is equal to or greater than the predefined temperature value of the fuel.

19. The method of claim 15, wherein the memory is further configured to store a database including a plurality of prestored maximum allowable fuel valve commands for the fuel valve at different discharge pressure values, and wherein the step of determining the maximum allowable fuel valve command for the fuel valve further includes querying, by the processor, the database to determine the maximum allowable fuel valve command corresponding to the current discharge pressure value.

20. The method of claim 15, wherein the engine is a gas turbine engine.
